(19) United States
(12) Patent Application Publication
(10) Pub. No.: US 2003/0145326 A1
(43) Pub. Date: Jul. 31, 2003

(54) Subscription to TV channels/shows based on recommendation generated by a TV recommender

(75) Inventors: Srinivas Gutta, Yorktown Heights, NY (US); James David Schaffer, Wappingers Falls, NY (US); Larry James Eshelman, Ossining, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/066,453

(22) Filed: Jan. 31, 2002

(51) Int. Cl. H04N 5/445

(52) U.S. Cl. 725/46; 725/51

(57) ABSTRACT

A system and method for subscribing TV programs according to the preferences of the user based on the user's past viewing history. The system keeps track of all the programs watched by the user to generate a profile indicative of the frequency of a particular program being watched. Then, a plurality of subscription plans based on the viewer's viewing habit stored in the user profile is offered to the user, so that the user can selectively pay for the programs of his or her interest, instead of paying for the entire programs.

### BACKGROUND OF THE INVENTION

1. Field of the Invention

The present invention relates to a system and method for subscribing television channels/shows based a recommendation made from the customer's preference or profile.

2. Description of the Invention

The modern world with huge amounts of multimedia content and varied delivery options gives us a tremendous variety and range of options and choices. Cable and satellite television deliver hundreds of different channels each carrying a different program. Currently, over 500 different program channels are shown through a cable television service. For subscription services such as satellite and cable TV, viewers have different payment options for some or all of the programs. For example, viewers are charged per program that they watch or a monthly flat rate for all programs in a particular channel or a group of channels. However, viewers must pay for the entire package even though they might be interested in subscribing to only certain channels or shows. Therefore, the present invention provides an alternative way for viewers to pay for TV channels or shows.

### SUMMARY OF THE INVENTION

The present invention is directed to a system and method for subscribing TV programs according to the preferences of the user based on the user's past viewing history, explicitly entered preferences, or preference profile derived from the viewer's feedback of a plurality of shows.

According to one aspect of the invention, a method of customizing a subscription plan is provided. The method includes the steps of: receiving a plurality of programs from a plurality of channels; monitoring each program watched by a user to generate a user profile indicating the frequency of a particular program watched by the user; recommending a plurality of subscription plans based on the user profile; selecting at least one program or one channel provided in the user profile for future subscription; and, displaying said selected program for viewing. The content of the user profile is classified according to predetermined criteria and also updated to reflect the user's changing preference. The method further includes the step of storing said selected program in a storage medium for subsequent replay.

According to another aspect of the present invention, the method includes the steps of: generating at least one user profile indicating the viewer's preference for a particular program type; comparing the user profile with incoming programs from a plurality of channels to determine a match; if there is match, recommending the matched programs to the viewer for future subscription; selecting at least one matched program for viewing at a particular time. The method further includes the steps of storing said selected program in a storage medium for subsequent replay and updating the content of the user profile to reflect the viewer's changing preference.

According to a further aspect of the invention, a system capable of customizing a subscription plan includes: means for receiving a plurality of programs from a plurality of channels; means for detecting each program watched by a user to generate a user profile, wherein the user profile indicates the user's preference for a particular program; means for recommending a plurality of subscription plans based on the user profile; and, means for selecting at least one program provided in the user profile for future subscription. The system further includes means for selecting at least one channel provided in the user profile for future subscription; an input means for performing the selection of channels interactively by the user; means for storing the selected program for subsequent retrieval; means for displaying the selected program for viewing; and, means for updating the content of the user profile to reflect said user's changing preference.

The foregoing and other features and advantages of the invention will be apparent from the following, more detailed description of preferred embodiments as illustrated in the accompanying drawings in which reference characters refer to the same parts throughout the various views. The drawings are not necessarily to scale, the emphasis is placed instead upon illustrating the principles of the invention.

### BRIEF DESCRIPTION OF THE DRAWINGS

The above and other features and advantages of the present invention will become more apparent from the following detailed description when taken in conjunction with the accompanying drawings, in which:

FIG. 1 illustrates a simplified block diagram of the system according to an embodiment of the present invention;

FIG. 2 shows major components of the system according to an embodiment of the present invention;

FIG. 3 is a flow chart illustrating a user profile development session in accordance with the present invention;

FIG. 4 is a diagram showing the user interface screen in accordance with the present invention; and,

FIG. 5 is a flow chart illustrating the operation steps in accordance with the present invention.

### DETAILED DESCRIPTION OF THE PREFERRED EMBODIMENT

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for the purpose of clarity, detailed descriptions of well-known devices, circuits, and methods are omitted so as not to obscure the description of the present invention with unnecessary detail.

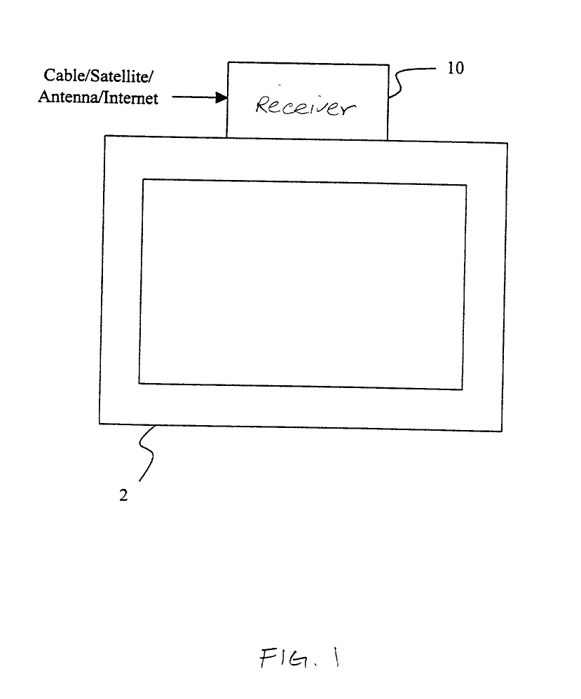

FIG. 1 shows a conventional television system 2 and a receiver 10 whereto the preferred embodiments of the present invention may be applied. The receiver 10 may also include other personal recording devices, such as ReplayTV (trademark of REPLAY NETWORKS, INC., of Palo Alto, Calif.) and TiVo (trademark of TIVO, Inc., of Sunnyvale, Calif.), that give the television viewer new abilities to capture and manipulate the stream of television shows, which flow from their cable and satellite systems. As shown in FIG. 1, the receiver 10 is configured to receive audio and video programming from the conventional television (TV) broadcast as well as other variety of sources, including a cable service provider, digital high definition television (HDTV) and/or digital standard definition television (SDTV) signals, a satellite dish, a conventional RF broadcast, an Internet connection, or another storage device, such as a VHS player or DVD player. The audio and video programming can be delivered in analog, digital, or digitally compressed formats via any transmission means, including satellite, cable, wire, television broadcast, or sent via the Web. It should be noted that the present system is also capable of being connected to other possible networks, such as a direct private network and a wireless network.

According to the embodiment of the present invention, viewers can select and pay for the programs in many different ways. First, viewers can select and pay for specific channels or shows of their interest. In addition, viewers can also select and pay for some or all the shows recommended by the receiver 10 based on the past viewing history, preference, or user profile. To achieve this, the receiver 10 detects incoming television programs from a plurality of different channels and maintains a database containing the viewing history of a particular viewer, then determines the type of TV programs or channels that are watched or not watched by the viewer. Note that receiver 10 may comprise a separate channel can be dedicated to receive the electronic program guide (EPG) data from a different source. Thereafter, a recommendation as to the type of programs or channels that the viewer likes to watch is generated according to the past viewing history. Therefore, the receiver 10 provides payment options for viewers to subscribe for a selected number of programs/channels, so that they do not have to pay for the entire package when they desire only some of the programs/channels.

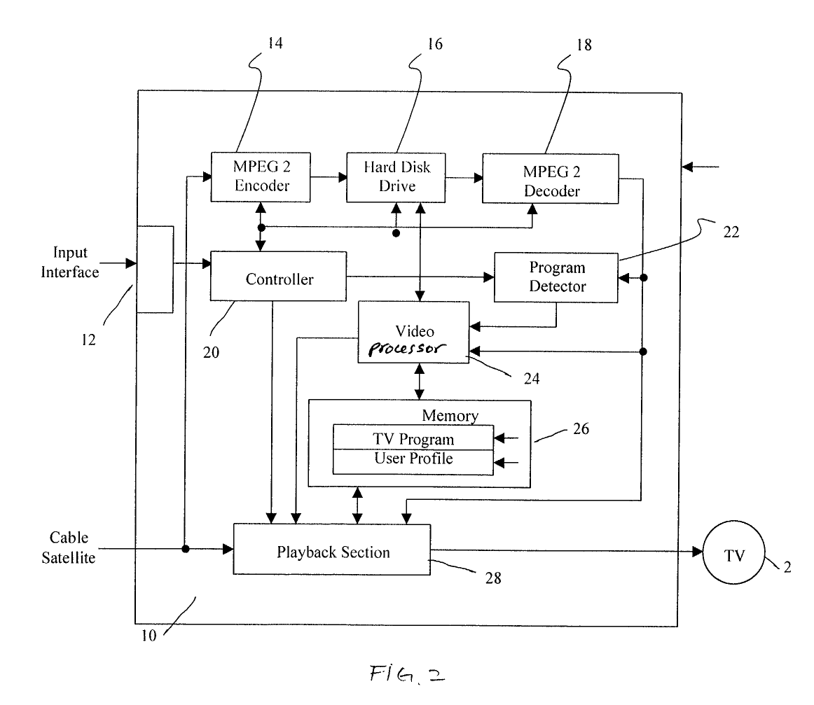

FIG. 2 illustrates an exemplary receiver 10 in greater detail according to the embodiment of the present invention. The receiver 10 includes an input interface (i.e., IR sensor) 12, MPEG-2 encoder 14, hard disk drive 16, MPEG-2 decoder, controller 20, program detector 22, video processor 24, memory 26, and playback section 28. It should be noted that the MPEG encoder/decoder may comply with other MPEG standards, i.e., MPEG-1, MPEG2, MPEG-4, and MPEG-7. The controller 20 oversees the overall operation of the receiver 10, including a detection mode, record mode, play mode, and other modes that are common in a personal recording device.

During a normal mode, the controller 20 causes the incoming television signals to be demodulated and processed by the video processor 24 and transmits them to the television set 2 for display. Then, the video processor 24 converts the incoming TV signals to the corresponding baseband television signals that are suitable for display on the television set 2.

During a recording mode, the controller 20 causes the MPEG-2 encoder 14 to receive incoming television signals delivered from satellite, cable, wire, and television broadcasts or the web and converts the received TV signals to the MPEG format for storage on the hard disk driver 16. Thereafter, the controller 20 causes the hard disk driver 16 to stream the stored television signals to the MPEG-2 decoder, which in turn transmits the decoded TV signals to be transmitted to the television set 2 via the play back section 28 for display.

At the same time, video information is input to a program detector 22 where the content of the video information is analyzed according to a pre-set classification. To this end, a well-known electronic program guide (EPG) protocol may be utilized. An EPG is a standard application designed to aid the viewer in the navigation of and selection from a broadcast material available in a TV environment. The EPG provides information about each program and includes programming characteristics, such as the channel number, program title, start time, end time, elapsed time, time remaining, rating (if available), topic, theme, and a brief description of the program's content. Using the EPG features, the program detector 22 classifies the incoming programs into one of the pre-set categories, i.e., sports, old classic movies, action movies, etc. The analysis outcome by the program detector 22 is then forwarded and stored in the memory 26. Note that classifying programs according to the content of the video information is well known in the art that can be performed in a variety of ways. In particular, Applicants have filed a few applications relating how to classify programs based on the user profile. See for example, U.S. patent application Ser. No. 09/466,406 filed on Dec. 17, 1999, U.S. patent application Ser. No. 09/627,139 filed on Jul. 27, 2000, U.S. patent application Ser. No. 09/666,401, and U.S. patent application Ser. No. 09/498,271 filed on Feb. 4, 2000, assigned to the same assignee, and herein incorporated by simple reference.

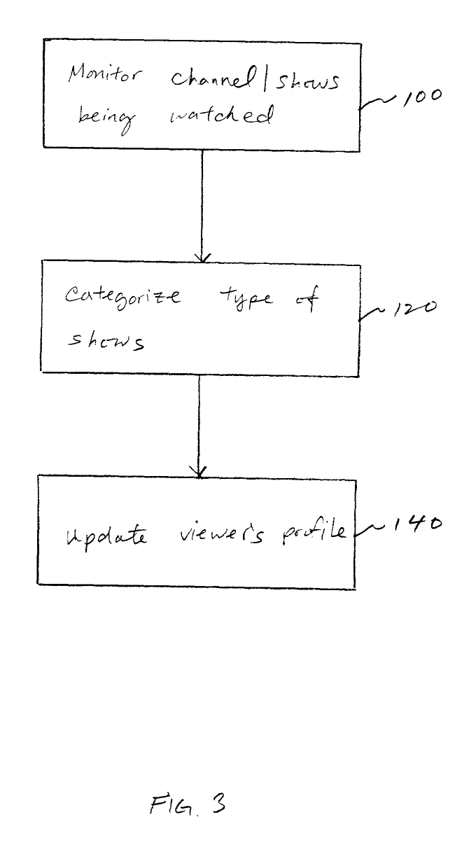

The program detector 22 also operates to process and generate data that is representative of the viewing history of a given user to determine the type of programs/channels most watched by the viewer, then generates the user's viewing habits to build a user profile in the memory 26. Alternatively, the viewer may explicitly designate the type of shows or programs he or she prefers when generating the user profile. FIG. 3 shows user profile development steps according to the embodiment of the present invention. The receiver 10 observes the user's viewing habits over time (step 100), during which each incoming video program is classified as described above (step 120). Here, the user's viewing habits, including the type of shows and the channels most frequently watched, and the data is ranked and used to build a user profile in the memory 26. Thus, a database reflecting the user's likes or dislikes of various channels and/or shows can be obtained based on the user's viewing pattern, such that the receiver 10 can later recommend a list of programs or channels that the viewer should pay for subscription.

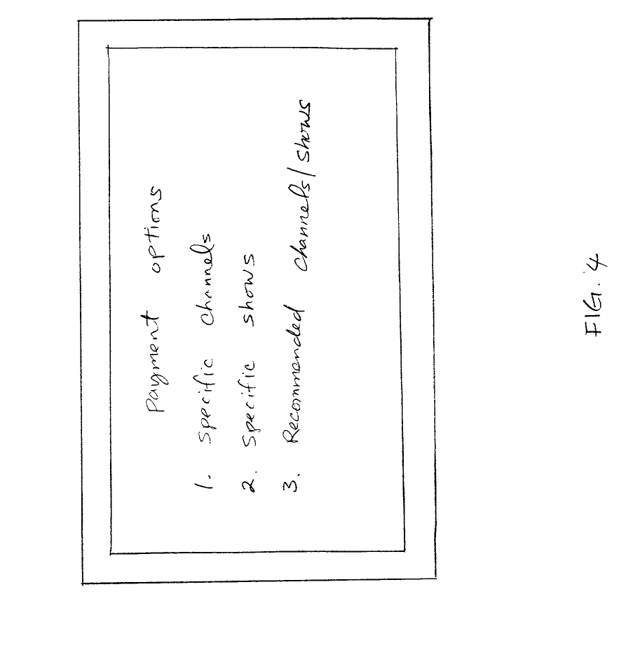

Referring to FIG. 4, the present invention allows a number of ways for viewers to pay for the programs or channels selectively as they wish. Thus, the viewer is able to customize the payment plan for viewing the designated channels or shows according to their preferences. To pay for only the desired TV channel (option 1) or show (option 2), a suitable interface exists between the user and the receiver 10 to gather the user's selection for the type of channel or show he or she wishes to watch. Here, the user may choose multiple TV programs or shows. Alternatively based on the classification of the video programs and the past viewing history, the receiver 10 can recommend channels or shows (option 3) that the viewer likes based on the past viewing history. As such, the user can elect to pay for some or all of the channels or shows recommended by the receiver 10.

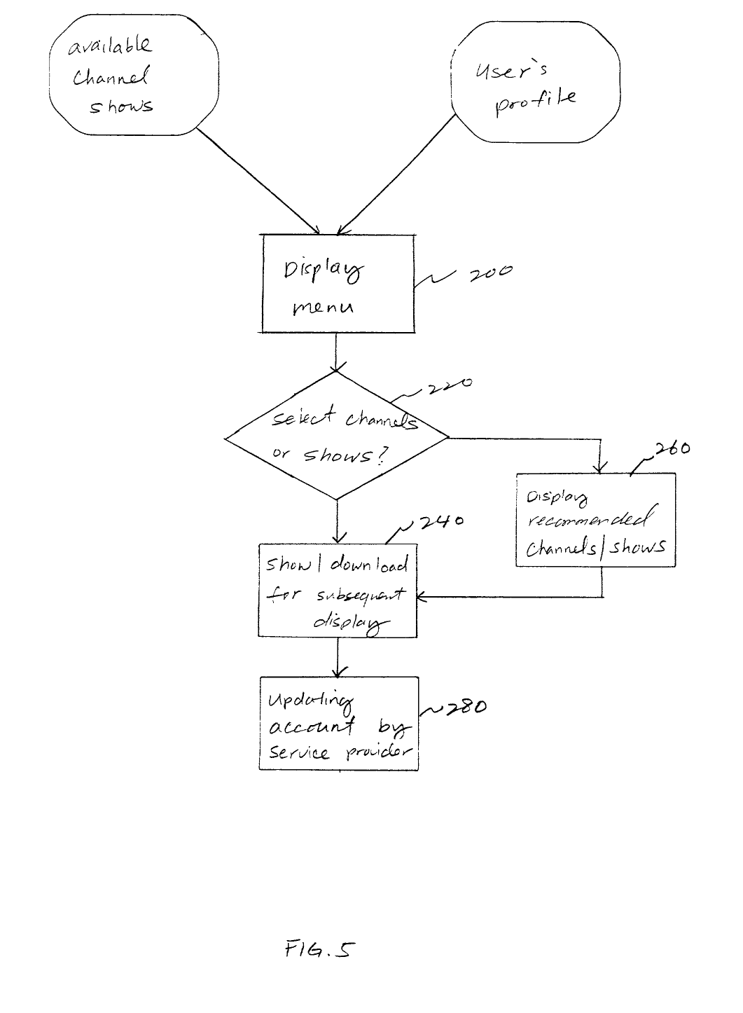

FIG. 5 illustrates the operation steps of customizing the payment options when subscribing to a cable or satellite service. Based on the incoming video programs from a cable or satellite service provider and the user's profile obtained as described in FIG. 3, the receiver 10 displays a payment option menu shown in FIG. 4 in response to a user's request in step 200. If the user enters specific channels or shows that he or she wishes to pay on a regular basis in step 220, the viewer will be charged only for those channels and shows in step 240. Here, the viewer has the option to schedule a recording of those particular channels or shows on a continuing basis for a subsequent display. However, if the requested channel or program is already in progress, the receiver 10 displays them on the TV monitor for viewing.

If the viewer selects another option in step 220, the receiver 10 recommends a number of shows that the viewer may be interested in paying the subscription for in step 260. By comparing the past user's profile and new incoming programs, the receiver 10 can also recommend a list of other new shows similar to the programs watched in the past. For example, if the viewer has a history of watching comedy shows more frequently than other programs, i.e., sports programs, the receiver 10 will recommend the viewer to pay for the comedy shows. In this similar manner, the receiver 10 recommends a number of shows that the viewer likes to watch based on the past history, so that the viewer is only paying for the shows of their interest. When given such recommendation, the viewer can further narrow down the recommended shows by choosing a select few of the top recommended shows. The viewer can also schedule a recording of all or selected recommended shows on a continuing basis for subsequent viewing. Finally, the viewers can be charged by the cable or satellite service provider according to the desired subscription plan, in step 280.

As a result, the viewer can begin watching, at the designated time, only the channels or shows of interest, thereby providing a more accurate billing experience to the viewer. Accordingly, viewers do not have to pay for shows they do not watch or that are of no interest to them. Thereafter, the viewer can perform a similar operation as described above to change the subscription plan as occasion demands. For example, if the viewer is going out of the country in the upcoming month, the viewer can instruct the receiver 10 to record all the programs that he or she subscribed for subsequent viewing upon return, or may change the subscription plan as desired.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention include all embodiments falling within the scope of the appended claims.

What is claimed is:

1. A method for customizing a subscription plan, the method comprising the steps of:
receiving a plurality of programs from a plurality of channels;
monitoring each of said plurality of programs watched by a user to generate a user profile indicative of a frequency of a particular program being watched by said user;
recommending a plurality of subscription plans based on said user profile; and,
selecting at least one program provided in said user profile for future subscription.

2. The method of claim 1, wherein said step of selecting channels is performed interactively in response to said user's input.

3. The method of claim 1, further comprising the steps of storing said selected program in a storage medium for subsequent replay, and charging said user only for the subsequently viewed program.

4. The method of claim 1, further comprising the step of displaying said selected program for viewing.

5. The method of claim 1, further comprising the step of updating the content of said user profile to reflect said user's changing preference.

6. The method of claim 1, wherein the step of monitoring each of said plurality of programs watched by said user further comprises the step of classifying the content of said plurality of programs according to predetermined criteria.

7. The method of claim 6, wherein said classification of each of said plurality of programs watched is performed according to an electronic program guide (EPG).

8. The method of claim 1, wherein said step of the selection of programs is performed interactively in response to said user's input.

9. A method for customizing a subscription plan for a viewer, the method comprising the steps of:
generating at least one user profile indicating said viewer's preference for a particular program;
comparing said user profile with incoming programs from a plurality of channels to determine a match;
if there is match. recommending said matched programs to said viewer for future subscription; and,
selecting at least one matched program for viewing at a particular time.

10. The method of claim 9, further comprising the step of storing said selected program in a storage medium for subsequent replay.

11. The method of claim 10, wherein said step of the selection of programs is performed interactively in response to said user's input.

12. The method of claim 9, further comprising the step of displaying said selected program for viewing.

13. The method of claim 9, further comprising the step of updating the content of said at least one user profile to reflect said viewer's changing preference.

14. A system for customizing a subscription plan, comprising:
means for receiving a plurality of programs from a plurality of channels;
means for detecting each of said plurality of programs watched by a user to generate a user profile, said user profile indicative of said user's preference for a particular program;
means for recommending a plurality of subscription plans based on said user profile; and,
means for selecting at least one program provided in said user profile for future subscription.

15. The system of claim 14, further comprising means for selecting at least one channel provided in said user profile for future subscription.

16. The system of claim 14, further comprising an input means for performing the selection of channels interactively by said user.

17. The system of claim 14, further comprising means for storing said selected program for subsequent retrieval.

18. The system of claim 14, further comprising means for displaying said selected program for viewing.

19. The system of claim 14, further comprising means for updating the content of said user profile to reflect said user's changing preference.

20. The system of claim 14, wherein the content of said user profile is classified according to predetermined criteria.
